(19) United States
(12) Patent Application Publication
(10) Pub. No.: US 2026/0199183 A1
(43) Pub. Date: Jul. 16, 2026

(54) TELESCOPIC DEVICE AND MASSAGER

(71) Applicant: Jie GUO, Xuzhou City (CN)

(72) Inventor: Jie GUO, Xuzhou City (CN)

(21) Appl. No.: 19/310,879

(22) Filed: Aug. 26, 2025

(30) Foreign Application Priority Data
Jan. 15, 2025 (CN) 202510059533.5

(51) Int. Cl. A61H 23/02

(52) U.S. Cl. CPC A61H 23/0254; A61H 2201/0111; A61H 2201/0157; A61H 2201/0165; A61H 2201/1215; A61H 2201/149; A61H 2201/1664; A61H 2201/1685

(57) ABSTRACT

The present invention discloses a telescopic device and a massager, comprising a drive motor, a telescopic mechanism connected to the drive motor, and a housing. The telescopic mechanism comprises a reciprocating screw rod and a sliding block with a sliding block hole through which the reciprocating screw rod passes. The reciprocating screw rod is connected to an output shaft of the drive motor so that rotation of the screw rod causes the sliding block to move axially in a reciprocating manner. A first guide member extends into a threaded groove of the reciprocating screw rod, and at least one set of guide assemblies is arranged on the sliding block. A sleeve tube is fixed to the sliding block, with one end extending out of the housing. The invention further discloses a massager, which comprises the telescopic device, enabling a compact structure, enhancing portability and expanding application scenarios.

### CROSS REFERENCE OF RELATED APPLICATION

This non-provisional application claims the benefit of priority under 35 U.S.C. § 120 to a prior non-provisional application, Chinese Patent Application No. CN2025100595335, filed on Jan. 15, 2025, which is incorporated herein by reference in its entirety.

### BACKGROUND OF THE PRESENT INVENTION

### Field of Invention

The present invention relates to a telescopic device and a massager.

### Description of Related Arts

Existing massagers (such as massage guns) and other health massage products that perform telescopic motion generally achieve linear reciprocating movement of the front head by driving an eccentric wheel linkage mechanism with a drive motor, and the reciprocating stroke is determined by the rotational radius of the eccentric wheel. When the reciprocating stroke is relatively long, the overall size of the product correspondingly becomes larger. Since the direction of the linear reciprocating movement is perpendicular to the shaft of the drive motor, the shape of the product is usually limited to a cross-shaped or a large plate-like structure, which is not suitable for users with small hands to grip during operation, resulting in inconvenience of user, and leading to a large storage footprint.

### SUMMARY OF THE PRESENT INVENTION

The objective of the present invention is to provide a telescopic device and a massager, so as to overcome the shortcomings of the prior art.

In order to overcome the above-mentioned problems, the present invention adopts the following technical solution:

A telescopic device, comprising a drive motor, a telescopic mechanism connected to the drive motor, and a housing, wherein the drive motor and the telescopic mechanism are disposed in the housing. The telescopic mechanism comprises a reciprocating screw rod and a sliding block, wherein the reciprocating screw rod is connected to an output shaft of the drive motor, so that, when the reciprocating screw rod rotates, the sliding block moves axially in a linear reciprocating manner along the reciprocating screw rod. A first guide member is provided in the sliding block, the first guide member extending into a threaded groove on a rod body of the reciprocating screw rod, and at least one set of guide assemblies is arranged on a surface of the sliding block.

Furthermore, each of the guide assemblies comprises a second guide member and a guide groove, the guide groove is provided in the housing, with the length of the guide groove covering the stroke of the sliding block, and the second guide member is arranged on the sliding block.

Furthermore, a sliding block hole is provided in the sliding block, the reciprocating screw rod passes through the sliding block hole, and the first guide member is arranged in the sliding block hole.

Furthermore, a first guide member slot is provided on the sliding block, one end of the first guide member slot communicates with the sliding block hole, and the other end of the first guide member slot penetrates through an end surface of the sliding block. The first guide member is arranged in the first guide member slot, a pressing member is provided on the first guide member, and a sliding block cover is arranged on the pressing member to close an end opening of the first guide member slot away from the sliding block hole.

Furthermore, the first guide member comprises a base and a guide block, the guide block is disposed in a threaded groove of the reciprocating screw rod.

Furthermore, the guide block is crescent-shaped, and a curvature of a crescent-shaped arc surface of the guide block matches a curvature of a bottom of the threaded groove.

Furthermore, the second guide member is a ball, a hemispherical recess is provided on a surface of the sliding block, and the second guide member is embedded in the hemispherical recess.

Furthermore, two sets of the guide assemblies are provided, and the two sets of guide assemblies are arranged opposite to each other.

Furthermore, a sleeve tube is provided on the sliding block, the sleeve tube is fixedly connected to the sliding block, and an end of the sleeve tube away from the sliding block extends out of the housing.

Furthermore, an end of the reciprocating screw rod away from the drive motor extends into the sleeve tube.

Furthermore, a ball guide sleeve is provided on the end of the reciprocating screw rod away from the drive motor, and balls of the ball guide sleeve are respectively in contact with an outer wall of the reciprocating screw rod.

Furthermore, the end of the reciprocating screw rod away from the drive motor has a rod body diameter smaller than a diameter of the rest of the reciprocating screw rod, forming a reduced-diameter section. The ball guide sleeve is sleeved on the reduced-diameter section, and the balls of the ball guide sleeve are respectively in contact with an inner wall of the sleeve tube and an outer wall of the reduced-diameter section.

Furthermore, a linear bearing is provided outside the sleeve tube, the linear bearing is fixed within the housing.

Furthermore, a rechargeable battery and a control board are provided within the housing, the control board is provided with a power indicator light, a switch, and/or a charging connector, and the control board is electrically connected to the rechargeable battery and the drive motor respectively.

The present invention further discloses a massager, which comprises a massage head and the telescopic device described above, wherein the massage head is connected to the sleeve tube.

Furthermore, a quick connector is provided on the sleeve tube, and the massage head is connected to the quick connector.

Compared with the prior art, the present invention replaces the existing eccentric wheel and connecting rod mechanism in the telescopic mechanism with a reciprocating screw rod and a sliding block, which solves the problem of large product size when the reciprocating stroke is long, makes the product easy to carry, and increases the usage scenarios. Moreover, due to the change in structure, the shape of the product is also changed, thereby providing greater design space for the product.

### BRIEF DESCRIPTION OF THE DRAWINGS

FIG. 1 a first schematic view of the external structure of the present invention.

FIG. 2 is a second schematic view of the external structure of the present invention.

FIG. 3 is an exploded schematic view of the present invention.

FIG. 4 is a first schematic view of the internal structure of the present invention.

FIG. 5 is a second schematic view of the internal structure of the present invention.

FIG. 6 is a schematic view of the connection between the ball guide sleeve and the reciprocating screw rod of the present invention.

FIG. 7 is a schematic view of the structure of the sliding block chamber of the present invention.

### DETAILED DESCRIPTION OF THE PREFERRED EMBODIMENT

The present invention will be further described in detail below with reference to the drawings and embodiments.

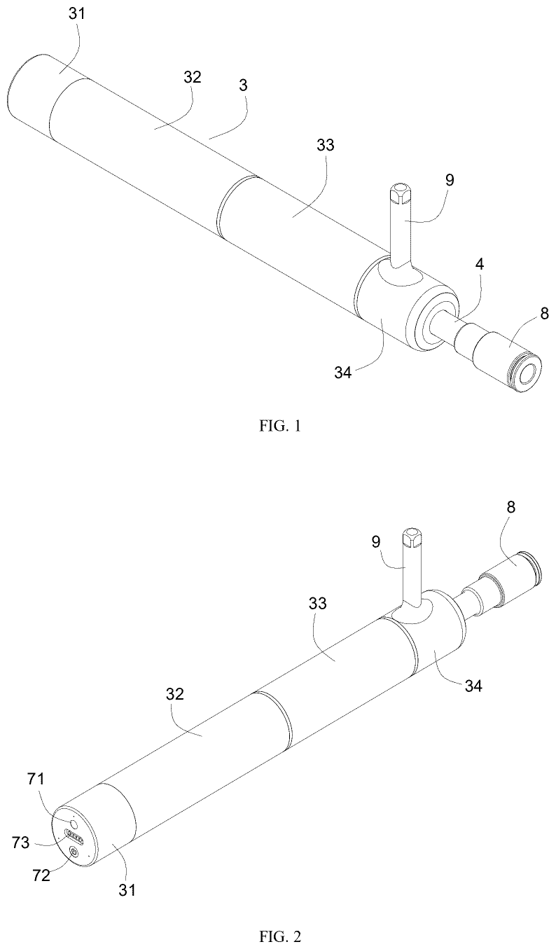

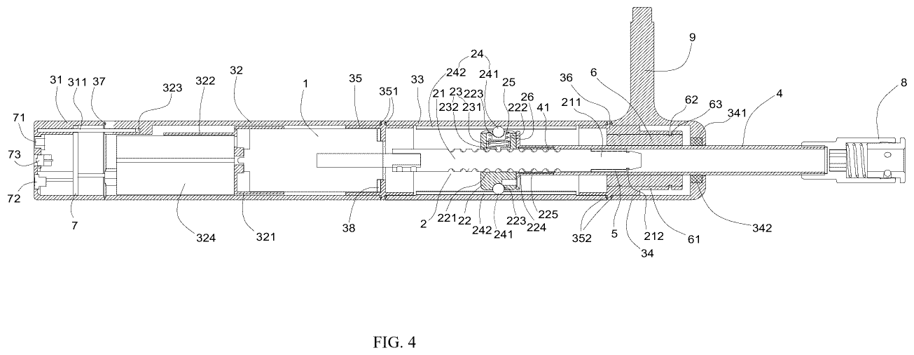

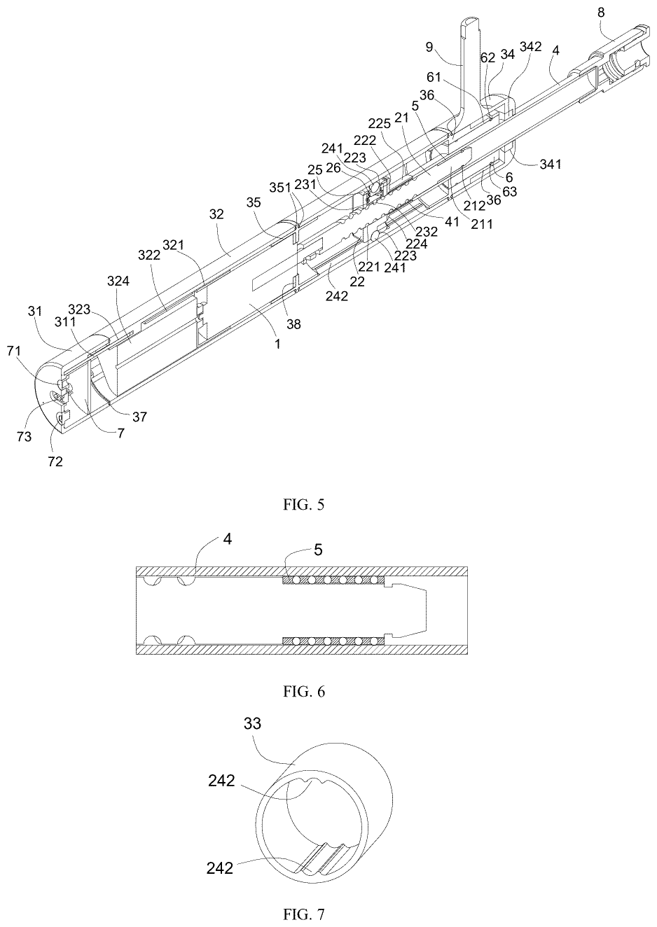

As shown in FIGS. 1 to 5, the present invention discloses a telescopic device comprising a drive motor (1), a telescopic mechanism (2) connected to the drive motor (1), and a housing (3), wherein:

The housing (3) is formed by four cylindrical sleeves of different lengths, which are tightly fitted together via connectors to constitute a linear structure, and sequentially comprises a circuit chamber (31), a battery and motor chamber (32), a sliding block chamber (33), and a linear bearing chamber (34). The battery and motor chamber (32) and the sliding block chamber (33) are tightly connected and fixed via a first flange (35), with a first sealing ring (351) provided for waterproof sealing. The sliding block chamber (33) and the linear bearing chamber (34) are tightly connected and fixed via a second flange (36), with a second sealing ring (352) provided for waterproof sealing. Both the first flange (35) and the second flange (36) are provided with central holes for passage of the output shaft of the drive motor (1) and the telescopic mechanism (2). Adhesive bonding is further used to fixedly connect: between the circuit chamber (31) and the battery and motor chamber (32); between the battery and motor chamber (32), the first flange (35) and the sliding block chamber (33); and between the sliding block chamber (33), the second flange (36) and the linear bearing chamber (34).

The drive motor (1) is fastened to the first flange (35) by screws. An end of the drive motor (1) away from the first flange (35) is provided with a motor connector (321), the motor connector (321) is ring-shaped, with one end being a closed surface and the other end, facing the drive motor (1), being an open surface provided with a groove inside. The motor connector (321) is tightly sleeved onto the drive motor (1).

The telescopic mechanism (2) is disposed in the sliding block chamber (33), the telescopic mechanism (2) comprises a reciprocating screw rod (21) and a sliding block (22). A sliding block hole (221) is provided in the sliding block (22), the reciprocating screw rod (21) passes through the sliding block hole (221), and the reciprocating screw rod (21) is connected to the output shaft of the drive motor (1) so that, when the reciprocating screw rod (21) rotates, the sliding block (22) moves axially in a linear reciprocating manner along the reciprocating screw rod (21). A first guide member (23), extending into a threaded groove on the rod body of the reciprocating screw rod (21), is arranged in the sliding block hole (221). At least one set of guide assemblies (24) is provided on a surface of the sliding block (22). A sleeve tube (4) is provided on the sliding block (22), the sleeve tube (4) is fixedly connected to the sliding block (22), and an end of the sleeve tube (4) away from the sliding block (22) extends out of a central through-hole in the linear bearing chamber (34). A quick connector (8) may be provided on the sleeve tube (4) for connection to a massage head or other components to enable quick attachment and detachment. A sealing ring is provided between the quick connector (8) and the sleeve tube (4) to prevent water from entering to the sleeve tube (4).

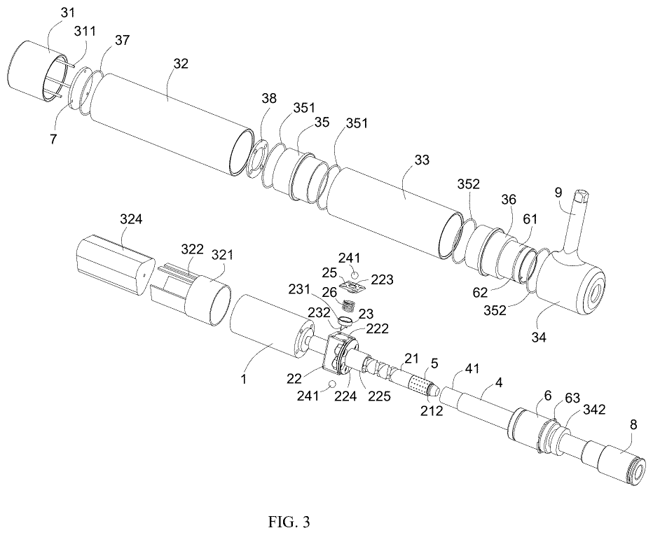

As shown in FIGS. 3, 4, and 5, the sliding block (22) is in the form of a rectangular block, with one end facing the sleeve tube (4) provided with a sleeve connector (224) fixed to the sliding block (22) by screws. The sleeve connector (224) is provided with a sleeve section (225) having an outer diameter equal to the outer diameter of the sleeve tube (4). The end of the sleeve tube (4) opposite to the sliding block (22) is provided with a sleeve insertion section (41) having an outer diameter adapted to the inner diameter of the sleeve section (225). The sleeve tube (4) is inserted into the sleeve section (225) via the sleeve insertion section (41). Specifically, the sleeve insertion section (41) is provided with an external thread, and the inner wall of the sleeve section (225) is provided with an internal thread, enabling threaded connection and fastening between the sleeve insertion section (41) and the sleeve section (225). The inner diameter of the sleeve tube (4) is slightly larger than the diameter of the reciprocating screw rod (21) so that, during movement of the sliding block (22), a portion of the reciprocating screw rod (21) is located within the sleeve tube (4).

As shown in FIGS. 3, 4, 5, and 6, to ensure smoother movement of the sleeve tube (4), the end of the reciprocating screw rod (21) away from the drive motor (1) has a rod body diameter smaller than that of the rest of the reciprocating screw rod (21), forming a reduced-diameter section (211). A ball guide sleeve (5) is sleeved onto the reduced-diameter section (211), and the balls of the ball guide sleeve (5) are respectively in contact with the inner wall of the sleeve tube (4) and the outer wall of the reduced-diameter section (211), thereby preventing contact between the inner wall of the sleeve tube (4) and the reciprocating screw rod (21) during linear reciprocating movement of the sleeve tube (4). The ball guide sleeve (5) is axially fixed on the reduced-diameter section (211) by a guide sleeve retaining ring (212), reducing friction when the reciprocating screw rod (21) rotates inside the sleeve tube (4) and ensuring the straightness of linear motion between the sliding block (22) and the sleeve tube (4).

In the present invention, as shown in FIGS. 3, 4, 5, and 7, each of the guide assemblies (24) comprises a second guide member (241) and a guide groove (242). The guide groove (242) is provided on the inner chamber wall of the sliding block chamber (33) and has a length covering the stroke of the sliding block (22). The second guide member (241) is provided on the sliding block (22). Specifically, the guide groove (242) is formed by a space enclosed between two protruding ribs, with the cross-section of the guide groove (242) being concave and arcuate. The protruding ribs extend along the length direction of the sliding block chamber (33). Preferably, two sets of the guide assemblies (24) are provided, and the two sets of guide assemblies (24) arranged opposite to each other in the sliding block chamber (33).

As shown in FIGS. 3, 4, 5, and 7, in a preferred embodiment, the second guide member (241) is a ball, with the curvature of the guide groove (242) adapted to the spherical surface of the second guide member (241). A hemispherical recess (223) is provided on the surface of the sliding block (22) opposite the guide groove (242), and the second guide member (241) is embedded in the hemispherical recess (223) in a non-detachable manner, thereby preventing the sliding block (22) from rotating radially due to friction when the reciprocating screw rod (21) rotates during operation, reducing friction and operational noise, and enabling the sliding block (22) to move only axially in a linear reciprocating manner.

As shown in FIGS. 3, 4, and 5, a first guide member slot (222) is provided on the sliding block (22), the lower end of the first guide member slot (222) communicates with the sliding block hole (221) and the upper end of the first guide member slot (222) penetrates through the upper end surface of the sliding block (22). The first guide member (23) is arranged in the first guide member slot (222). An pressing member (26) with elasticity is provided on the first guide member (23), and a sliding block cover (25) is provided on the pressing member (26) to close an end opening of the first guide member slot (222) away from the sliding block hole (221). The sliding block cover (25) is fastened to the sliding block (22) by screws. Specifically, the first guide member (23) comprises a base (231) and a guide block (232) with a crescent-like shape. The base (231) matches the shape of the first guide member slot (222), and the curvature of the crescent arc surface of the guide block (232) matches the curvature of a bottom of the threaded groove. The guide block (232) is disposed in the threaded groove of the reciprocating screw rod (21). The lower end of the second guide member (241) is placed in a recess at the upper end of the sliding block cover (25). The pressing member (26) provides appropriate pressure to prevent excessive contact between the guide block (232) and the surface of the threaded groove, thereby avoiding excessive friction that may hinder movement, and preventing potential jamming between the two components.

In one embodiment of the present invention, the second guide members (241) are arranged at opposite ends relative to the first guide member (23), with one of the hemispherical recess (223) formed on the sliding block cover (25). The pressing member (26) is a spring, the balls are steel balls, and the use of a spring as the pressing member (26) provides appropriate pressure to allow smooth movement of the guide block (232) and the sliding block (22). Since contact between the guide block (232) and the threaded groove can cause wear by friction and create gaps, the spring can push the guide block (232) to compensate for the gaps, thereby ensuring smooth movement of the guide block (232) in the threaded groove.

As shown in FIGS. 3, 4, and 5, the linear bearing chamber (34) is a circular cover-shaped structure, with one end has an opening tightly connected to the second flange (36), while the other end is a closed surface with a central hole through which the sleeve tube (4) extends. The end of the second flange (36) facing the linear bearing housing (34) is provided with a bearing seat (61) having a annular shape. The bearing seat (61) has a linear bearing hole, the linear bearing hole communicates with the central hole of the second flange (36). A retaining ring groove (62) partially penetrates the body of the bearing seat (61) is provided on the bearing seat (61). A linear bearing (6) is provided in the bearing seat (61), and a bearing retaining ring (63) is provided on the linear bearing (6). When the linear bearing (6) is inserted into the linear bearing hole, the bearing retaining ring (63) partially engages with the retaining ring groove (62), fixing the linear bearing (6) in the bearing seat (61). The bearing retaining ring (63) has a polygonal structure that inserts into the retaining ring groove (62). The sleeve tube (4) passes through the linear bearing (6).

As shown in FIGS. 3, 4, and 5, the central hole of the linear bearing chamber (34) is provided with a stepped hole (341), a waterproof and dustproof ring (342) is provided in the stepped hole (341). The sleeve tube (4) passes through the waterproof and dustproof ring (342) to achieve waterproof and dustproof, preventing water or foreign matter from entering the product during linear reciprocating motion of the sleeve tube (4).

As shown in FIGS. 3, 4, and 5, a rechargeable battery (324) is provided in the battery and motor chamber (32). The end of the motor connector (321) away from the drive motor (1) is provided with a battery connection slot (322), and the rechargeable battery (324) is inserted and secured in the battery connection slot (322). The closed surface of the motor connector (321) is provided with holes for cable routing. A control board (7) is provided in the circuit chamber (31), and the control board is provided with a power indicator light (71), a switch (72), and a charging connector (73) that are electrically connected to the control board (7). The end of the circuit chamber (31) away from the battery and motor chamber (32) is provided with openings exposing the power indicator light (71), the switch (72), and the charging connector (73). The control board (7) is electrically connected to the rechargeable battery (324) and the drive motor (1) respectively, thereby controlling the drive motor (1).

As shown in FIGS. 3, 4, and 5, the circuit chamber (31) is provided with insertion posts (311) extending toward the battery and motor chamber (32). Correspondingly, the battery and motor chamber (32) is provided with insertion slots (323). By inserting the insertion posts (311) into the insertion slots (323), the circuit chamber (31) is fixed to the battery and motor chamber (32). A third waterproof ring (37) is provided between the circuit chamber (31) and the battery and motor chamber (32), thereby achieving sealed waterproof. The control board (7) may be circular and secured in the circuit chamber (31) via the insertion posts (311).

As shown in FIGS. 3, 4, and 5, a vibration damping pad (38) is provided between the drive motor (1) and the first flange (35) to reduce operational vibrations towards the product during operation of the drive motor (1). As can be seen from the figures, the first flange (35) is provided with a circumferential annular protrusion, and the circumferential annular protrusion is provided with through holes. The drive motor (1) is secured to the annular protrusion by screws passing through the through holes and engaging with threaded holes on a housing of the drive motor (1). The vibration damping pad (38) is positioned between the annular protrusion and the drive motor (1).

As shown in FIGS. 1 to 5, the outer wall of the linear bearing chamber (34) is provided with a quick-connect male head (9) having rod shape for attaching to compatible brackets.

As shown in FIGS. 1 to 5, the present invention further discloses a massager, comprising telescopic device describe above. The massage head is connected to the quick connector (8). As the extension device has been previously described in detail, it will not be reiterated here.

The present invention provides these technical advantages:
1. Through the application of the reciprocating screw rod and sliding block, the product maintains small even during large reciprocating stroke, facilitating ease of use and portability.

The integrated design of the product provides waterproof and dustproof performance, expanding the range of application scenarios.

What is claimed is:

1. A telescopic device, comprising a drive motor (1), a telescopic mechanism (2) connected to said drive motor (1), and a housing (3), wherein said drive motor (1) and said telescopic mechanism (2) are disposed in said housing (3), said telescopic mechanism (2) comprises a reciprocating screw rod (21) and a sliding block (22), wherein said reciprocating screw rod (21) is connected to an output shaft of said drive motor (1), when said reciprocating screw rod (21) rotates, said sliding block (22) moves axially in a linear reciprocating manner along said reciprocating screw rod (21), a first guide member (23) is provided in said sliding block (22), said first guide member (23) extending into a threaded groove on a rod body of said reciprocating screw rod (21), and at least one set of guide assemblies (24) is arranged on a surface of said sliding block (22).

2. The telescopic device, as recited in claim 1, wherein each of said guide assemblies (24) comprises a second guide member (241) and a guide groove (242), said guide groove (242) is provided in said housing (3) with a length covering a stroke of said sliding block (22), and said second guide member (241) is arranged on said sliding block (22).

3. The telescopic device, as recited in claim 1, wherein a sliding block hole (221) is provided in said sliding block (22), said reciprocating screw rod (21) passes through said sliding block hole (221), and said first guide member (23) is arranged in said sliding block hole (221).

4. The telescopic device, as recited in claim 3, wherein a first guide member slot (222) is provided on said sliding block (22), one end of said first guide member slot (222) communicates with said sliding block hole (221), and the other end of said first guide member slot (222) penetrates through an end surface of said sliding block (22), said first guide member (23) is arranged in said first guide member slot (222), a pressing member (26) is provided on said first guide member (23), and a sliding block cover (25) is arranged on said pressing member (26) to close an end opening of said first guide member slot (222) away from said sliding block hole (221).

5. The telescopic device, as recited in claim 4, wherein said first guide member (23) comprises a base (231) and a guide block (232), said guide block (232) is disposed in said threaded groove of said reciprocating screw rod (21).

6. The telescopic device, as recited in claim 5, wherein said guide block (232) is crescent-shaped, and a curvature of a crescent-shaped arc surface of said guide block (232) matches a curvature of a bottom of said threaded groove.

7. The telescopic device, as recited in claim 2, wherein said second guide member (241) is a ball, a hemispherical recess (223) is provided on said surface of said sliding block (22), and said second guide member (241) is embedded in said hemispherical recess (223).

8. The telescopic device, as recited in claim 1, wherein two sets of said guide assemblies (24) are provided, and the two sets of said guide assemblies (24) are arranged opposite to each other.

9. The telescopic device, as recited in claim 2, wherein two sets of said guide assemblies (24) are provided, and the two sets of said guide assemblies (24) are arranged opposite to each other.

10. The telescopic device, as recited in claim 7, wherein two sets of said guide assemblies (24) are provided, and the two sets of said guide assemblies (24) are arranged opposite to each other.

11. The telescopic device, as recited in claim 1, wherein a sleeve tube (4) is provided on said sliding block (22), said sleeve tube (4) is fixedly connected to said sliding block (22), and an end of said sleeve tube (4) away from said sliding block (22) extends out of said housing (3).

12. The telescopic device, as recited in claim 11, wherein an end of said reciprocating screw rod (21) away from said drive motor (1) extends into said sleeve tube (4).

13. The telescopic device, as recited in claim 12, wherein a ball guide sleeve (5) is provided on said end of said reciprocating screw rod (21) away from said drive motor (1), and balls of said ball guide sleeve (5) are respectively in contact with an outer wall of said reciprocating screw rod (21).

14. The telescopic device, as recited in claim 13, wherein said end of said reciprocating screw rod (21) away from said drive motor (1) has a rod body diameter smaller than a diameter of the rest of said reciprocating screw rod (21), forming a reduced-diameter section (211), said ball guide sleeve (5) is sleeved on said reduced-diameter section (211), and said balls of said ball guide sleeve (5) are respectively in contact with an inner wall of said sleeve tube (4) and an outer wall of said reduced-diameter section (211).

15. The telescopic device, as recited in claim 11, wherein a linear bearing (6) is provided outside said sleeve tube (4), and said linear bearing (6) is fixed within said housing (3).

16. The telescopic device, as recited in claim 12, wherein a linear bearing (6) is provided outside said sleeve tube (4), and said linear bearing (6) is fixed within said housing (3).

17. The telescopic device, as recited in claim 13, wherein a linear bearing (6) is provided outside said sleeve tube (4), and said linear bearing (6) is fixed within said housing (3).

18. The telescopic device, as recited in claim 14, wherein a linear bearing (6) is provided outside said sleeve tube (4), and said linear bearing (6) is fixed within said housing (3).

19. The telescopic device, as recited in claim 1, wherein a rechargeable battery (324) and a control board (7) are provided within said housing (3), said control board (7) is provided with a power indicator light (71), a switch (72), and/or a charging connector (73), and said control board (7) is electrically connected to said rechargeable battery (324) and said drive motor (1) respectively.

20. A massager, comprising a massage head and a telescopic device, said telescopic device comprises a drive motor (1), a telescopic mechanism (2) connected to said drive motor (1), and a housing (3), wherein said drive motor (1) and said telescopic mechanism (2) are disposed in said housing (3), said telescopic mechanism (2) comprises a reciprocating screw rod (21) and a sliding block (22), wherein said reciprocating screw rod (21) is connected to an output shaft of said drive motor (1), when said reciprocating screw rod (21) rotates, said sliding block (22) moves axially in a linear reciprocating manner along said reciprocating screw rod (21), a first guide member (23) is provided in said sliding block (22), said first guide member (23) extending into a threaded groove on a rod body of said reciprocating screw rod (21), and at least one set of guide assemblies (24) is arranged on a surface of said sliding block (22), wherein a sleeve tube (4) is provided on said sliding block (22), said sleeve tube (4) is fixedly connected to said sliding block (22), and an end of said sleeve tube (4) away from said sliding block (22) extends out of said housing (3), wherein said massage head is connected to said sleeve tube (4).

21. The massager, as recited in claim 20, wherein a quick connector (8) is provided on said sleeve tube (4), and said massage head is connected to said quick connector (8).
